(19) United States
(12) Patent Application Publication
(10) Pub. No.: US 2024/0347821 A1
(43) Pub. Date: Oct. 17, 2024

(54) CYLINDRICAL BATTERY CELL WITH NOTCHES

(71) Applicant: NORTHVOLT AB, Stockholm (SE)

(72) Inventors: Dominique LIGEOIS, Västeras (SE); Jeong Keun KWON, Västeras (SE); Tetsuya MAKINO, Solna (SE); Kenya SHATANI, Stockholm (SE)

(21) Appl. No.: 18/683,825

(22) PCT Filed: Aug. 19, 2022
(86) PCT No.: PCT/EP2022/073173

§ 371 Date: Feb. 15, 2024

(30) Foreign Application Priority Data
Aug. 19, 2021 (SE) 2151006-0

(51) Int. Cl. H01M 50/124; H01M 10/04; H01M 50/107

(52) U.S. Cl. CPC H01M 50/1243; H01M 10/0422; H01M 50/107

(57) ABSTRACT

A cylindrical secondary cell (10) comprises a conductive sheet (20, 30) with a longitudinal direction, one or more coatings (24, 26) formed on the conductive sheet (20, 30), wherein the conductive sheet (20, 30) comprises a portion free of coating along an end side of the conductive sheet (20, 30), a plurality of notches (50) formed on the end side of the conductive sheet (20, 30) which is free of coating, wherein the notches (50) start on the edge of the conductive sheet (20, 30) and extend in the direction towards the coating (24, 26), and wherein the notches (50) are formed with a linear portion (52) and an end portion (54), wherein the end portion comprises a rounded cut out or is formed with a turn so that the end of the end portion is not directed towards the coating (24, 26), and that the part of the notches (50) closest to the coating (24, 26) is arranged within 2.5 mm or less from the coating (24, 26).

### FIELD OF THE INVENTION

The invention relates to a cylindrical battery cell having notches on a conductive sheet with specially formed end portion close to a coating.

### PRIOR ART

In battery manufacturing it is known in the art to provide a conductive sheet with a coating that is rolled up into a cylinder. In tabless cells, the conductive sheet has an uncoated edge protruding on a side of the cylinder. To create a good surface to connect a terminal to, the uncoated edge can be pressed or folded. When folded, notches can be formed in the uncoated part to facilitate folding without buckling the conductive sheet.

After the conductive sheet has been coated, it is pressed in a calendaring treatment to get a desired thickness of the coating. In the calendaring treatment, stress is introduced in the interface region between the coated and uncoated part due to the difference in thickness.

To avoid tearing of the conductive sheet, a heat treatment can be used in combination with the calendaring process. However, in the calendaring process, the IHA treatment does not fully eliminate the risk of tearing in the conductive sheet.

There is a need for a way to reduce the risk of tearing of the conductive sheet.

### SUMMARY OF THE INVENTION

An object of the invention is to provide a cylindrical secondary cell which is more resistant to tearing and where the damage will be reduced if tearing occurs. The object is achieved by a cylindrical secondary cell according to claim 1. Preferred embodiments are depicted in the dependent claims.

A cylindrical secondary cell according to the invention comprises a conductive sheet with a longitudinal direction, one or more coatings formed on the conductive sheet, wherein the conductive sheet comprises a portion free of coating along an end side of the conductive sheet, a plurality of notches formed on the end side of the conductive sheet which is free of coating, wherein the notches start on the edge of the conductive sheet and extend in the direction towards the coating, and wherein the notches are formed with a linear portion and an end portion, wherein the end portion comprises a rounded cut out or is formed with a turn so that the end of the end portion is not directed towards the coating, and that the part of the notches closest to the coating is arranged within 2.5 mm or less from the coating, preferably 2.2 mm, 2.1 mm, or 2 mm or less. Since the end portion is formed such that it does not have a sharp corner pointing in the direction towards the inner part of the conductive sheet, but pointing in a direction at least parallel to the longitudinal direction, the conductive sheet will not tear inwards and the damage in case of tearing is greatly reduced. That the notches are arranged close to the coating ensures that the tabs formed by the notches can be folded close to the coating to create a flat surface for connecting a terminal of the secondary cell. The conductive sheet with the one or more coatings may be wound in the longitudinal direction into a cylindrical shape, i.e. a jelly roll.

The conductive sheet may further comprise a bent contact portion, wherein the bent contact portion is arranged within the plurality of notches, in particular 5 mm or less from the coating, preferably 4 mm or 3 mm or less. The notches form tabs in the uncoated part. The tabs may be folded to create a bent contact portion which is the part of the tabs which are folded to connect to a terminal of the secondary cell. The fold may be arranged anywhere along the notch but preferably as close as possible to the coating. The bent contact portion is formed on the area of the conductive sheet that is free from any coating and serves to fold the side edge portion of the conductive sheet that is used to connect the conductive sheet with a plus or minus pol, i.e. a terminal, of the battery.

The notches may have essentially a consistent width over their length up to the end portion, or a consistent width over their entire length. Cutting the notches with a consistent width may ease the manufacturing of the notches.

The cylindrical secondary cell can further comprise a second conductive sheet wherein at least one coating is formed on the second conductive sheet and the second conductive sheet comprises a portion free of coating along an end side, wherein the second conductive sheet comprises notches on the portion free of coating. The notches may be arranged like the notches from the first conductive sheet. It should be noted that the second conductive sheet with its coating may be arranged in the same way as the first conductive sheet with regards to how the notches are arranged.

The notches may be spaced apart more than 2 mm preferably 3 mm, 4 mm, 5 mm but less than 9 mm, preferably 8 mm or 7 mm, most preferably the notches are spaced apart 6 mm. In this range, the amount of notches are ideal for the purpose of the bent contact portions.

As previously discussed in the background, the conductive sheet comprises a stressed portion in the area around the interface between coated and uncoated part. According to some aspects, at least a part of the end portion of the notches is arranged within the stressed portion. The complete end portion of the notches may be arranged within the stressed portion. In this way, the increased risk of tearing in the stressed portion is minimized due to the end portion of the notch being a rounded cut out or is formed with a turn so that the end of the end portion is not directed towards the coating. The end portion of the notches can be formed with a cut-out area at the end or the end portion of the notches can be formed with a curve or turn of the notch.

The notches may end in a straight line parallel to the longitudinal direction of the conductive sheet or the end line is directed towards the end side of the conductive sheet that is free of coating. In this way the notch can reliably prevent that in the case of tearing, the tear goes inwards and into the coating of the conductive sheet. If there is a tear, it will be guided parallel into another notch (and stop there) or outwards to the edge of the conductive sheet.

The notches can differ in length and/or their shape to their adjacent notches. This allows to combine different formed notches for different purposes, e.g. to arrange the notches closer together.

According to some aspects, the one or more coatings comprise a first coating and a second coating. The first coating being formed on the conductive sheet and the second coating being formed over the interface between the first coating and the conductive sheet such that it is formed on a part of the first coating and directly on part of the conductive sheet.

The at least one notch may extend at least into the second coating. It may also into the first coating. In other words, at least one notch extends into at least one coating. This may also be beneficial to reduce tearing in the conductive sheet.

A method for manufacturing a cylindrical secondary battery cell according to the invention comprises the steps of providing a conductive sheet with a longitudinal direction, forming one or more coatings on the conductive sheet, wherein the conductive sheet comprises a portion free of coating along an end side of the conductive sheet, forming a plurality of notches on the end side of the conductive sheet which is free of coating, starting on the edge of the conductive sheet and proceeding in the direction towards the coating, wherein the notches are formed with a linear portion and an end portion, wherein the end portion comprises a rounded cut out or is formed with a turn so that the end of the end portion is not directed towards the coating, and that the part of the notches closest to the coating is arranged within 2.5 mm or less from the coating, preferably 2.2 mm, 2.1 mm or 2 mm or less. The advantages with manufacturing the cylindrical secondary cell this way is the same as described above in connection to the different aspects of the cell.

### BRIEF DESCRIPTION OF THE FIGURES

FIG. 1 shows an isometric view of a rolled up conductive sheets having notches;

FIG. 2a shows a top view of a conductive sheet which can be cut to form two conductive sheets;

FIG. 2b shows a top view of a conductive sheet with a first coating applied to the conductive sheet, it can be cut to form two conductive sheets with coating and uncoated part;

FIG. 2c shows a top view of a conductive sheet which can be cut along the middle where a second coating is arranged in the interface region of the first coating and the uncoated part;

FIG. 2d shows the same as FIG. 2c but with some example notches in the uncoated parts; and

FIGS. 3a-f show different embodiments of notches.

### PREFERRED EMBODIMENTS OF THE INVENTION

When in the following directions like “up”, “down”, “left” and “right” are used they always refer to the respective Figure referenced.

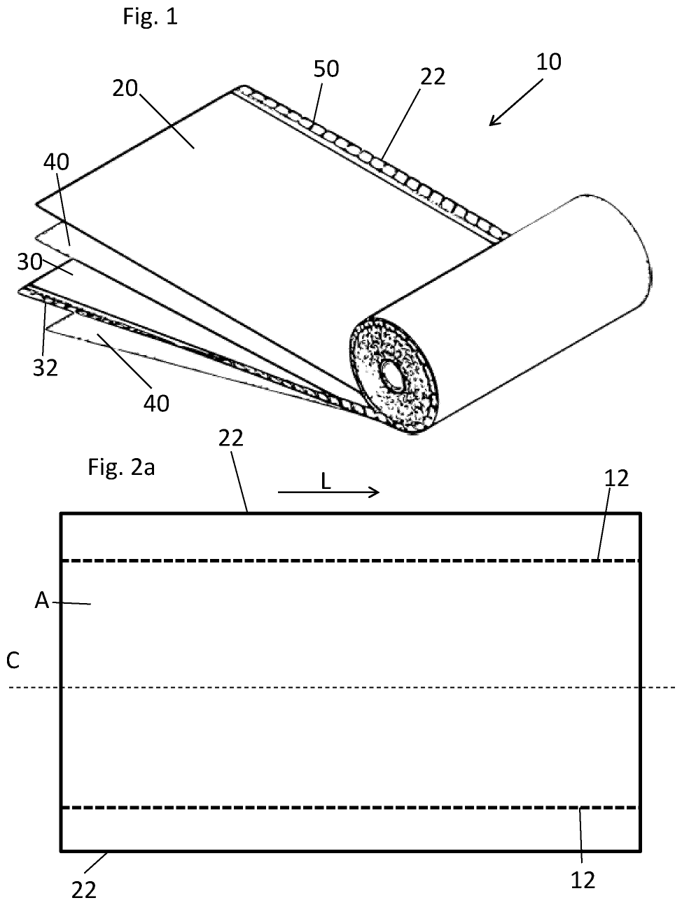

FIG. 1 shows an isometric view of a, so called, jelly roll 10 of a cylindrical secondary cell. The jelly roll 10 normally consists of a first conductive sheet 20 and a second conductive sheet 30, both sheets with respective electrode coating, arranged with separator sheets 40 in between and rolled to a jelly roll 10. The jelly roll 10 is shown in a state during the rolling of the conductive sheets 20, 30 and the separators 40. In the jelly roll 10 of a cylindrical secondary cell, the coating on one of the conductive sheets is a positive electrode and the coating of the other conductive sheet is then the negative electrode of the secondary cell.

A conductive sheet 20, 30 with coating forming a positive electrode may for example be made of aluminium. A conductive sheet 20, 30 with coating forming a negative electrode may for example be made of copper. The conductive sheets 20, 30 comprise one or more coatings, forming electrode coatings, will be described later. Notches 50 are cut, or otherwise formed, into the side edges 22, 32 of the conductive sheets 20, 30. These notches 50 in FIG. 1 are merely schematically shown. Due to the notches 50, the side edge 22, 32 forms tabs which can be bent inwards to the rotation axis after the different stacked layers of the secondary cell 10 are rolled up.

It should be noted that the jelly roll is then arranged in a can with terminals and parts connecting the electrodes of the jelly to the terminal to form the cylindrical secondary cell.

The arrangement can also include one or more vents and insulating parts. There are many ways to design these parts and they will not be described herein.

Also, the materials of the conductive sheets 20, 30 and the coatings thereon is not disclosed herein. Many different material choices can be used and is up to the implementer.

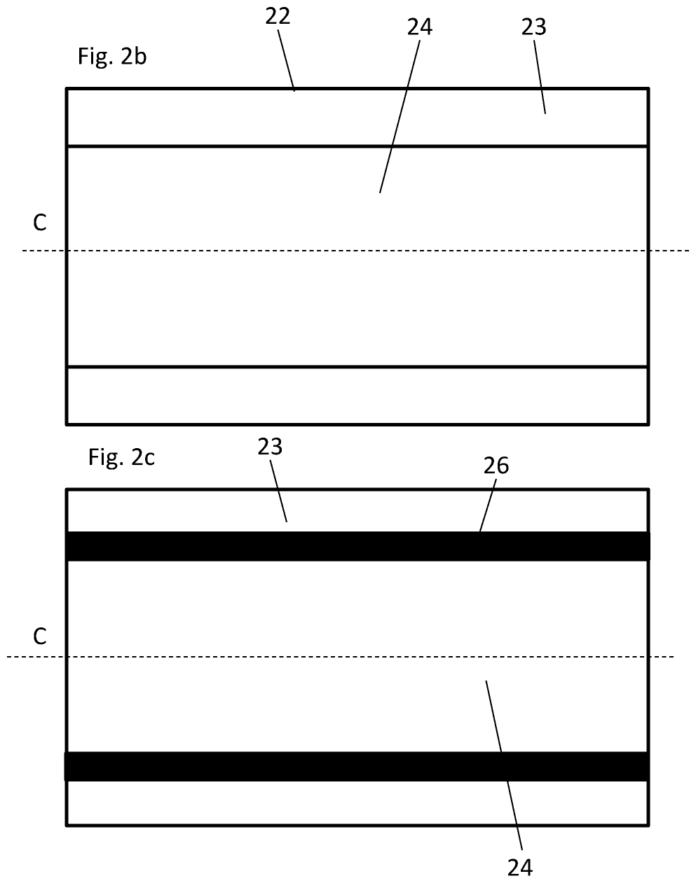

FIGS. 2a-d show a method for producing, for instance, a conductive sheet 20, 30 for a cylindrical secondary cell 10, where two conductive sheets are produced on one sheet which is then cut in half to form two separate sheets. The conductive sheets are provided as a coiled or rolled up continuous material on which the following manufacturing steps are carried out and which is then cut off at predetermined intervals for the appropriate length of a conductive sheet for a single cylindrical secondary cell. Additionally, the centre line C indicates the middle of the continuous material and serves to illustrate a middle cutting line where the conductive sheet 20, 30 is cut into the appropriate size as described later. This enables to manufacture not only one conductive sheet 20, 30, but two (one in the upper half and one on the lower half) since the upper and lower half are symmetrical.

In FIG. 2a, the conductive sheet 20, 30 is provided. The dotted line 12 indicates where the coating is to be arranged on the conductive sheet 20, 30. In other words, the coating is to be arranged between the two dotted lines 12. The conductive sheet 20, 30 with its coating may be subjected to a rolling, pressing and/or calendaring treatment which induce stress into the conductive sheet 20, 30 at the interface between the coated and uncoated part of the conductive sheet, i.e. the area around the dotted line 12. The treatment strengthens the structure of an inner area A of the conductive sheet 20, 30 and also ensures that the coating is of desired thickness and density. The area A is located between the two dotted lines 12.

In FIG. 2b, a first coating 24, 34 is applied to the conductive sheet 20, 30 and applied onto the area A. The conductive sheet 20, 30 is thus partly coated with a first layer 24. This first coating is an electrode layer and is applied to the middle part of the conductive sheet 20, 30.

It should be noted that if a conductive sheet is produced which is not to be cut in the middle to form two sheets, the first coating is applied on one side of the sheet and leaving the edge free of coating. The electrode layer may be either a positive electrode layer or a negative electrode layer. The first coating 24, 34 can cover less or all of the area A, but it can also cover an area closer to the edge 22, 32 than the area A. However, the side edge 22, 32 of the conductive sheet comprises an area 23, 33 that is free of any coating. After the first coating is placed on the conductive sheet 20, 30, the above mentioned rolling, pressing and/or calendaring treatment may be applied to the coated conductive sheet 20, 30. Stress is then introduced at the interface region due to the difference in thickness of the coated and uncoated part.

In FIG. 2c, a second coating 26, 36 is applied over the edges of the first coating 24, 34, i.e. the interface of the first coating 24, 34 and the uncoated conductive sheet 20, 30. The second coating 26, 36 is illustrated by the black bar. _{This} second coating comprises an insulating material and extends closer to the side edge 22, 32 than the first coating 24, 34. The second coating is for example an insulating coating or an insulating tape. The second coating comprises, for example, any of, or a combination of a polymer layer and an inorganic oxide layer comprising, for example, a binder or a dispersion agent. The polymer layer may comprise any of, or a combination of, polyethylene, polypropylene, polyphenylene ether, polybenzimidazole, polyimide, polyether imide, polyamidoimide, polyphenylene sulfide, polyethersulfone, polysulfone, polyether ketone, polymethylpentene, alamide, polyvinylidene fluoride, polyamide, polyethylene terephthalate, polybutylene terephthalate, polyallylate, polyacetal, polyvinyl chloride, and polychloride. The inorganic oxide layer may, for example, comprise, any of, or a combination of: SiO₂, TiO₂, Al₂O₃, AlOOH, γ-AlOOH, ZrO₂, SnO₂, CeO₂, MgO, CaO, ZnO, Y₂O₃, Pb(Zr,Ti)O₃ (PZT), PLZT, PB(Mg_{1/3}Nb_{2/3})O₃-PbTiO₃ (PMN-PT), BaTiO₃, hafnia (HfO₂) and SrTiO₃. Further, the second coating 26, 36 does not cover the complete first coating 24, 34 and does also not extend to the side edge 22, 32 of the conductive sheet 20, 30. Thus, the uncoated area 23, 33 is smaller after coating with the second coating 26, 36 compared to after the application of the first coating 24, 34.

After the application of the second coating 26, 36, the notches 50 are cut into the conductive sheet 20, 30. In FIG. 2d, the notches 50 are merely schematically shown. For the sake of illustration, the notches 50 on the left side are extending into the first and/or the second coating, whereas on the right side, the notches 50 are not extending into the coating. In a battery cell, all notches 50 may be the same shape, length and/or are regularly spaced apart from each other. However, it may also be the case that the shape, the width and/or the length of the notches 50 can differ from one another, as can the distance in which adjacent notches 50 are spaced apart from each other.

The notches are for example spaced apart 2 mm, more than 3 mm, 4 mm or 5 mm, but less than 9 mm, for example less than 8 mm or 7 mm. The notches are, for example, spaced apart 6 mm.

It is possible to form the notches at any state of the manufacturing process, i.e. before applying the calendaring or pressing treatment, but also before applying the first or second coating 24, 34, 26, 36. The notches 50 may also be formed after the calendaring or pressing treatment. For that reason, the notch 50 can extend into one or more coating 24, 34, 26, 36 without being actually cut into the coating 24, 34, 26, 36 itself. The notches 50 can be formed by means of a laser, die cut, a water jet, milling tools, grinding tools or any other appropriate way known in the art.

Finally, the conductive sheet is cut into the right length and also cut in half at the centre line C. Of course, it is also possible to only manufacture the upper half of the conductive sheet 20, 30 so that the cut at the centre line C is not carried out. The first and second conductive sheet 20, 30 is manufactured similarly, but use different materials for the conductive sheet 20, 30 and the first and second coatings 24, 34, 26, 36, as well as not apply a second coating 26, 36, depending on the intended use and purpose.

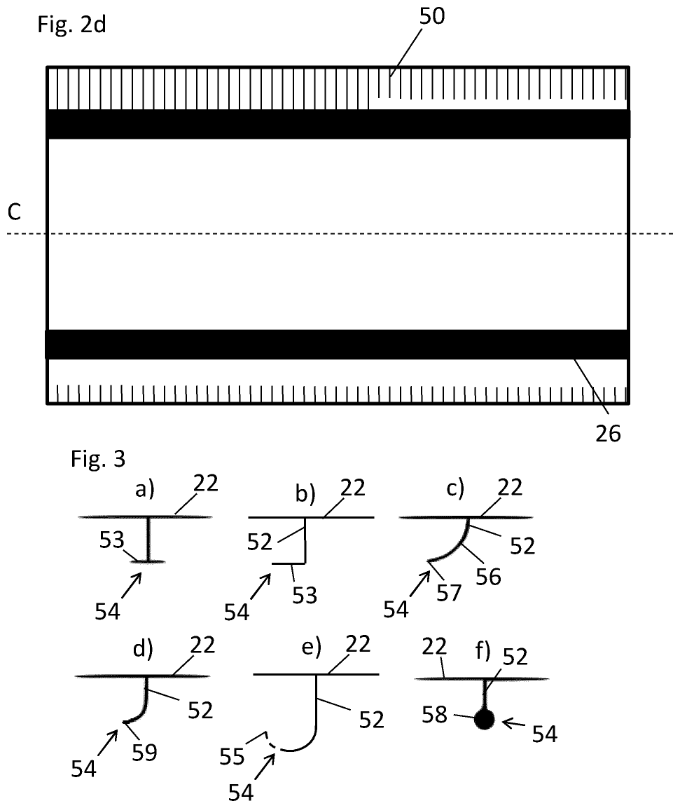

In FIGS. 3a-f are illustrated notches with linear portions 52 and different end 54 portions.

In FIG. 3a, the notch has a longer linear portion and at the end of the linear portion the end portion takes a 90° degree turn so that the end portion comprises a second linear portion 53 that is directed parallel to the longitudinal direction L of the conductive sheet and extends in both directions from the linear portion 52. FIG. 3b shows a similar embodiment to the one of FIG. 3a, but here after the turn, the end portion 54 only extends in one direction from the linear portion 52. In this case, it can extend a little bit further away from the linear portion 52 since it does not need to take the other side of an adjacent notch into account. Here it is shown that the linear portion extends to the left of the linear portion 52, but it is also possible to extend to the right side instead if the left side.

FIGS. 3c-d show similar embodiments with a linear portion 52 and an end portion 54 that comprises a curved portion 56. In FIG. 3c, the linear portion is shorter (less than 1.5 mm) and the end portion starts close to the side edge 22. It curves with a radius of 4-7 mm and turns also at least 90° degrees, so that the end 57 of the end portion 54 is not directed into the conductive sheet, but is at least parallel to the longitudinal direction L or is directed towards the side edge 22 (i.e. away from the centre line C). FIG. 3d comprises a longer linear portion 52 and a shorter end portion 54 compared to the embodiment of FIG. 3c. Here, the end portion 54 comprises a second linear portion at the end 59 after the curved portion, this second linear end 57 being again at least parallel to the longitudinal direction L. FIG. 3e shows an embodiment with a linear portion 52 and an end portion 54 including a curved portion 56. Here however, the curved portion does not stop curving when it is parallel to the longitudinal direction L, but extends further in a direction towards the side edge 22. This can be only a small portion, or can end up in a 180° degree turn as depicted by the dotted end line 55. Again, the end of the end portion can also be formed as a second linear portion.

FIG. 3f shows another embodiment of an end portion 54 that is formed as a rounded cut out portion 58. The illustrated embodiment shows a circular cut out portion, but any other rounded cut out portion will be possible as well, for example an oval form or a square or rectangular form with rounded edges (radius bigger than 1 mm).

After cutting the conductive sheets 20, 30 with the respective notches and first and/or second coatings 24, 26, the conductive sheets are stacked with the other layers, i.e. separators and second conductive sheet, and rolled up in a cylindrical form, i.e. jelly roll, to be further placed in a housing, i.e. can, and formed into a battery cell as known in the art.

### REFERENCE LIST

longitudinal direction L
subjected area A
Center line C
jelly roll 10
dotted line 12
conductive sheet 20
side edge 22
area free of coating 23
first coating 24
second coating 26
conductive sheet 30
side edge 32
area free of coating 33
first coating 34
second coating 36
notch 50
linear portion 52
linear portion 53
end portion 54
dotted end line 55
curved portion 56
end of the end portion 57
cut out portion 58
linear end 59

1-14. (canceled)

15. Cylindrical secondary cell (10) comprising:
a conductive sheet (20, 30) with a longitudinal direction;
one or more coatings (24, 26) formed on the conductive sheet (20, 30), wherein the conductive sheet (20, 30) comprises a portion free of coating along an end side of the conductive sheet (20, 30); and
a plurality of notches (50) formed on the end side of the conductive sheet (20, 30) which is free of coating, wherein the notches (50) start on the edge of the conductive sheet (20, 30) and extend in the direction towards the coating (24, 26),
wherein:
the notches (50) are formed with a linear portion (52) and an end portion (54), wherein the end portion comprises a rounded cut out or is formed with a turn so that the end of the end portion is not directed towards the coating (24, 26), and
the part of the notches (50) closest to the coating (24, 26) is arranged within 2.5 mm or less from the coating (24, 26).

16. Cylindrical secondary battery (10) cell according to claim 15, wherein the conductive sheet (20, 30) comprises a bent contact portion, wherein the bent contact portion is arranged within the plurality of notches (50).

17. Cylindrical secondary battery (10) cell according to claim 16, wherein the bent contact portion is arranged 5 mm or less from the coating (24, 26).

18. Cylindrical secondary battery cell (10) according to claim 16, wherein a bent contact portion is arranged in the linear portion (52) of the notch.

19. Cylindrical secondary battery cell (10) according to claim 15, wherein a bent contact portion is arranged in the linear portion (52) of the notch.

20. Cylindrical secondary battery cell (10) according to claim 15, wherein the notches (50) have essentially a consistent width over their length up to the end portion (54).

21. Cylindrical secondary battery cell (10) according to claim 15, wherein the notches (50) have essentially a consistent width over their entire length.

22. Cylindrical secondary battery cell according to claim 15, further comprising a second conductive sheet (20, 30) wherein at least one coating (24, 26) is formed on the second conductive sheet (20, 30) and the second conductive sheet (20, 30) comprises a portion free of coating (24, 26) along an end side, wherein the second conductive sheet (20, 30) comprises notches (50) on the portion free of coating.

23. Cylindrical secondary battery cell (10) according to claim 15, wherein the notches (50) are spaced apart more than 2 mm but less than 9 mm.

24. Cylindrical secondary battery cell (10) according to claim 15, wherein the conductive sheet (20, 30) comprises a stressed portion, and at least a part of the end portion (54) of the notches (50) is arranged within the stressed portion.

25. Cylindrical secondary battery cell (10) according to claim 15, wherein the notches (50) are formed with a cut-out area (58) at the end.

26. Cylindrical secondary battery cell (10) according to claim 15, wherein the end portion (54) of the notches (50) are curved.

27. Cylindrical secondary battery cell (10) according to claim 15, wherein the notches (50) end in a straight line (53, 59) parallel to the longitudinal direction of the conductive sheet (20, 30) or is directed towards the end side of the conductive sheet (20, 30) free of coating.

28. Cylindrical secondary battery cell (10) according to claim 15, wherein the notches (50) differ in length and/or their shape to their adjacent notches (50).

29. Cylindrical secondary battery cell (10) according to claim 15, wherein the one or more coatings (24, 26) comprise a first coating (24) and a second coating (26), the first coating (24) being formed on the conductive sheet (20, 30) and the second coating (26) being formed over the interface between the first coating (24) and the conductive sheet (20, 30) such that it is formed on a part of the first coating (26) and directly on part of the conductive sheet (20, 30), and wherein the at least one notch extends at least into the second coating (26).

30. Cylindrical secondary battery cell (10) according to claim 15, wherein at least one notch extends into at least one coating (24, 26).

31. Method for manufacturing a cylindrical secondary battery cell, the method comprising the steps of:
providing a conductive sheet (20, 30) with a longitudinal direction;
forming one or more coatings (24, 26) on the conductive sheet (20, 30), the conductive sheet (20, 30) comprises a portion free of coating along an end side of the conductive sheet (20, 30); and
forming a plurality of notches (50) on the end side of the conductive sheet (20, 30) which is free of coating, starting on the edge of the conductive sheet (20, 30) and proceeding in the direction towards the coating,
wherein:
the notches (50) are formed with a linear portion (52) and an end portion (54), wherein the end portion (54) comprises a rounded cut out or is formed with a turn so that the end of the end portion (54) is not directed towards the coating, and
the part of the notches (50) closest to the coating is arranged within 2.5 mm or less from the coating.
